(19) United States
(12) Patent Application Publication
(10) Pub. No.: US 2025/0140801 A1
(43) Pub. Date: May 1, 2025

(54) CATHODE ACTIVE MATERIAL FOR SECONDARY BATTERY

(71) Applicant: L&F CO., LTD., Daegu (KR)

(72) Inventors: Su Youn KWON, Daegu (KR); Kyung Min KIM, Daegu (KR); Jin Hyeon LIM, Daegu (KR); Dong Woo KIM, Daegu (KR); Sung Kyun CHANG, Daegu (KR); Jae Hak JEONG, Daegu (KR)

(21) Appl. No.: 18/692,410

(22) PCT Filed: Oct. 12, 2022
(86) PCT No.: PCT/KR2022/015348

§ 371 Date: Apr. 15, 2024

(30) Foreign Application Priority Data
Oct. 20, 2021 (KR) 10-2021-0140078

(51) Int. Cl. H01M 4/36; H01M 4/525; H01M 4/62; H01M 10/42

(52) U.S. Cl. CPC H01M 4/366; H01M 4/525; H01M 4/62; H01M 10/4235

(57) ABSTRACT

Disclosed is a cathode active material for secondary batteries including a core containing lithium transition metal oxide, a first coating portion formed on at least a part of the surface of the core, and a second coating portion formed on at least a part of the surface of the core where the first coating portion is not formed and optionally covering a surface of the first coating portion, wherein the first coating portion has a higher crystalline area proportion and the second coating portion has a higher amorphous area proportion. The cathode active material can improve structural stability and prevent electrolyte side reactions by effectively suppressing oxygen desorption or the like, thereby providing a secondary battery with desired characteristics.

### TECHNICAL FIELD

The present invention relates to a cathode active material including a coating layer, and more specifically, to a cathode active material including a core containing a lithium transition metal oxide and a coating layer including a specific first coating portion and a second coating portion.

### BACKGROUND ART

Lithium secondary batteries are used in various fields such as mobile devices, energy storage systems, and electric vehicles due to the high energy density and voltage, long cycle life, and low self-discharge rate thereof.

Such lithium secondary batteries may require better characteristics in devices or equipment to which the lithium secondary batteries are applied. For this purpose, there is a need to improve the characteristics of the cathode active material, which is a core element of lithium secondary batteries.

Generally, surface coating is a widely used method of improving the properties of cathode active materials.

Surface coating improves electrochemical properties by forming a coating layer containing a specific element on the surface of the core particle. Material(s) suitable for the desired properties are selected to form the coating layer.

There are well-known coating methods of optimizing the type, thickness, and content of coating materials to improve properties.

However, these methods have limitations in improving properties using a coating layer. Therefore, there is a need for development of methods from a novel perspective to further improve electrochemical properties using a coating layer.

### DISCLOSURE

### Technical Problem

Therefore, the present invention has been made to solve the above and other technical problems that have yet to be solved.

Therefore, as a result of extensive research and various experimentation, the present inventors developed a cathode active material including a combination of a first coating portion and a second coating portion based on specific morphology and characteristics and found that the cathode active material can provide high-performance and high-capacity secondary batteries due to excellent structural stability and suppressed electrolyte side reactivity. Based on this finding, the present invention was completed.

### Technical Solution

In accordance with an aspect of the present invention, provided is a cathode active material for secondary batteries including a core containing lithium transition metal oxide, a first coating portion formed on at least a part of the surface of the core, and a second coating portion formed on at least a part of the surface of the core where the first coating portion is not formed and optionally covering a surface of the first coating portion, wherein the first coating portion has a relatively higher crystalline area proportion and the second coating portion has a relatively higher amorphous area proportion.

A typical structural stability problem of cathode active materials is oxygen desorption that occurs during repetitive charging and discharging. This oxygen desorption generates an excessive amount of NiO being a rock salt structure in the layered structure of the cathode active material and increases Li by-products. NiO gradually increases during repeated charging and discharging, resulting in higher resistance. As Li by-products increase, various side reactions occur, ultimately leading to deterioration in battery performance such as capacity reduction. Therefore, the problem of oxygen desorption should be solved in terms of structural stability of the cathode active material.

According to the present invention, in order to implement a high-capacity and high-performance secondary battery required for devices or equipment, a secondary battery that can exhibit structural stability by suppressing oxygen desorption and fundamentally solve the problem of side reactions that occur when the core comes into contact with the electrolyte solution, resulting in excellent performance, can be obtained using a combination of a first coating portion capable of imparting structural stability to a lithium transition metal oxide-based core in a cathode active material and a second coating portion capable of minimizing local uncoated areas caused by the specific morphology of the first coating portion.

In the cathode active material for secondary batteries of the present invention, the core contains a lithium transition metal oxide containing transition metals including lithium, nickel or the like, and such lithium transition metal oxide may, for example, contain a composition represented by the following Formula (1):

Li[LiₓM_{1-x-y}D_{y}]O_{2-z}Q_{z} (1)
wherein M is at least one transition metal element stable in a four-coordinate or six-coordinate system;
D is a dopant which is at least one element selected from alkaline earth metals, transition metals, and non-metals;
Q is at least one anion; and
x, y and z satisfy 0≤x≤0.1, 0≤y≤0.1, and 0≤z≤0.2, respectively.

For reference, when D is a transition metal, the transition metal defined in M may be excluded from these transition metals.

M is, for example, at least one element selected from the group consisting of Ni, Co and Mn, D is for example at least one element selected from the group consisting of Al, W, Si, V, B, Ba, Ca, Zr, Ti, Mg, Ta, Nb and Mo, and Q is, for example, at least one element selected from the group consisting of F, S, and P.

In one specific example, the core may be a lithium transition metal oxide containing Ni, and the content of Ni may be 60 mol % or more, based on the total content of the transition metal, which increases oxygen desorption. In particular, the content of Ni may be 70 mol % or more, 80 mol % or more, or 90 mol % or more, which greatly increases oxygen desorption.

The lithium transition metal oxide may have a crystalline structure other than the layered crystalline structure. Examples of such crystalline structures include spinel crystalline structure and olivine crystalline structure, but are not limited thereto.

The average particle diameter (D50) of the core may be, for example, in the range of 1 to 50 μm, but is not particularly limited. In addition, the core may be provided in the form of a primary particle, a secondary particle including agglomerated primary particles, or a mixture of primary particles and secondary particles, but is not limited thereto.

The lithium transition metal oxide forming the core of the composition can be manufactured by a method known in the art and the description thereof is thus omitted herein.

As previously defined, in the cathode active material according to the present invention, the first coating portion has a relatively higher crystalline area proportion and the second coating portion has a relatively higher amorphous area proportion.

In this unique morphology, the crystalline structure constituting the crystalline area of the first coating portion may be formed by chemical bonding with a very strong bonding force with the core surface. Therefore, the crystalline raw material constituting the coating portion, for example, binds strongly to Li-M (transition metal)-Oₓ of the core to suppress structural destabilization such as oxygen desorption. On the other hand, the crystalline structure has poor spreadability due to concentration of constituent elements to form a regular repeating structure and thus is highly likely to form an island/spot type coating layer because it is difficult to uniformly coat the entire core surface when forming the coating layer. When the coating layer is formed in the form of islands or spots, the core surface exposed to the outside causes side reactions of the electrolyte, making the core surface unstable and ultimately resulting in deterioration of battery characteristics.

To prevent these problems, the second coating portion, which has a high amorphous area proportion, coats the remaining outer surface of the core which was not coated with the first coating portion, thus minimizing the uncoated area. Compared to the crystalline structure, the amorphous structure constituting the amorphous area of the second coating portion has less crowding to form a regular repeating structure of atoms, and thus has better spreadability. That is, the amorphous coating portion with a lower crystallinity has relatively higher spreadability, whereas the crystalline coating portion with high crystallinity has relatively lower spreadability. Therefore, the uncoated area of the core can be effectively coated with the second coating portion, which has lower crystallinity and better spreadability, thereby minimizing side reactions with the electrolyte solution.

In one specific embodiment, the first coating portion may be a crystalline/amorphous combination structure that optionally includes an amorphous area. The crystalline/amorphous combination structure binds strongly to the Li-M (transition metal)-Oₓ structure of the core, thus suppressing structural instability such as oxygen desorption, when the area based on the crystalline structure (“crystalline area”) is more than the area based on the amorphous structure (“amorphous area”). Specifically, the crystalline area may be 60% or more of the total core area. When the proportion of the crystalline area increases, the bond force to the surface increases. Therefore, the crystalline area may preferably be 70% or more, more preferably 80% or more, or 90% or more. In some cases, the first coating portion may have a crystalline area with a proportion close to 100%, in other words, may be formed of a crystalline structure.

In addition, the second coating portion may be a crystalline/amorphous combination structure that optionally includes an crystalline area. In order to ensure excellent spreadability of the crystalline/amorphous combination structure, the amorphous area should be greater than the crystalline area. Therefore, the amorphous area may be more than 60% of the total coating area. The amorphous area may be 60% or more, preferably 70% or more, more preferably 80% or more, or 90% or more so that the second coating portion can be effectively formed on the core surface on which the first coating portion has not been formed. In some cases, the second coating portion may have a crystalline area with a proportion close to 100%, that is, a amorphous structure.

As described above, the proportion of the crystalline or amorphous area of the crystalline/amorphous combination structure may be calculated by randomly selecting a measurement spot of the surface of any one cathode active material particle using a transmission electron microscope (TEM). For example, the surface of the cathode active material on which the second coating portion including the crystalline/amorphous combination structure is formed is measured at 500,000 times with a TEM, and 20 points of the second coating portion were randomly selected from the measured image. When 12 of the 20 points are determined amorphous, the amorphous proportion may be calculated to be 60%, that is, the amorphous proportion in the crystalline/amorphous combination structure is 60%. Likewise, the surface of the cathode active material on which the first coating portion including a crystalline/amorphous combination structure is formed is measured at 500,000 times with a TEM, and 20 points of the first coating portion are randomly selected from the measured image. When 12 of the 20 points are determined crystalline, the crystalline proportion may be calculated to be 60%, that is, the crystalline proportion in the crystalline/amorphous combination structure is 60%.

In one specific embodiment, the first coating portion may have a structure in which 20% or more of the core surface area is coated, and specifically, 30% or more or 40% or more is coated. When the first coating portion is coated to less than 20% of the core surface area, the effect obtained by formation of the coating layer may not be realized.

The second coating portion may coat the uncoated area of the core, where the first coating portion is not formed, and may optionally coat a part or all of the first coating portion, and specific examples thereof are shown in FIG. 1.

FIG. 1(a) shows an active material in which a second coating portion is formed in an uncoated area of the core where the first coating portion is not formed and the entire first coating portion. FIG. 1(b) shows an active material in which a second coating portion is formed in an uncoated area of the core where the first coating portion is not formed and a part of the first coating portion. The second coating portion can reduce the uncoated area of the core on which the first coating portion is not formed. Specifically, the second coating portion may be formed in 50% or more, preferably 70% or more, and most preferably 90% or more, of the area where the first coating portion is not formed. When the second coating portion is formed in less than 50% of the area where the first coating is not formed, the effect of the coating layer may not be realized. Therefore, it is desirable to form the second coating portion in as much of the area where the first coating is not formed as possible.

The application areas of the first coating portion and the second coating portion are determined by selecting any cathode active material particle from an image measured using a transmission electron microscope (TEM), selecting any measurement spot on the surface of the positive active material particle, and calculating the ratio of the coating portion to the core surface. For example, when 20 core surface points are randomly selected from a 500,000× image of the cathode active material on which the first coating portion and the second coating portion are formed using a TEM, and the first coating portion is found to be formed at 4 of the 20 points, the first coating portion is determined to coat 20% of the core surface. In addition, when 20 core surface points where the first coating portion was not formed were randomly selected from a 500,000× image of the cathode active material on which the first coating and the second coating were formed using a TEM, and the second coating portion was formed at 10 of the 20 points, the second coating portion is determined to coat 50% of the uncoated area of the core surface.

In the present invention, the coating structure provides structural stability while suppressing side reactions of the electrolyte. Therefore, it is not necessary to coat the entire outer surface of the first coating portion as long as the second coating portion can cover the uncoated area of the core where the first coating portion has not been coated. By controlling the conditions for forming the second coating portion while sequentially forming the first coating portion and the second coating portion during the coating process, it is possible to minimize the phenomenon in which the area where the first coating portion is not formed is not coated with the second coating portion. Therefore, it should be interpreted in the present invention that the second coating portion includes the area where the first coating portion is coated and the area where the first coating portion is not coated.

As can be seen from the TEM analysis of the experiment described later, the first coating portion and the second coating portion can exhibit differentiated properties due to the respective characteristics thereof.

As a first example, in a 20 to 1,000,000× image measured with a transmission electron microscope (TEM), there may be one or more areas where the first coating portion is discontinuously formed.

As a second example, in a 20 to 1,000,000× image measured with a transmission electron microscope (TEM), there may be one or more areas where the second coating portion is continuously formed while covering the first coating portion and the core.

In one specific example, the first coating portion and the second coating portion each independently contain one or more elements selected from Al, B, W, Co, Zr, Ti, Si, Mg, Ca, V, Sr, Zn, Ga, Sn, Ru, Ce, La, Hf, Ta, and Ba. These elements as various compounds, preferably oxides, may form the coating portion.

In the first coating portion, during the heat treatment process, elements (X) react with oxygen in the atmosphere to form oxides, but some elements react with oxygen in the core to form oxides, providing a strong bond to the core. In some cases, elements may also react with lithium by-products present on the outer surface of the core to form an oxide with a Li—X—O structure. In particular, Al may form a Li—Al—O structure as an oxide, and specifically, Al may form a Li—Al—O structure including one or more crystalline phases among α-LiAlO₂ (hexagonal), β-LiAlO₂ (monoclinic), γ-LiAlO₂ (tetragonal), and Li₃AlO₃, or may form a structure including other crystalline phases. The first coating portion may also bind to the transition metal of the core. In this case, an oxide with a Li-M (at least one transition metal element stable in a four-coordinate or six-coordinate system)-X—O structure may be formed.

The elements constituting the oxide in the first coating portion and the oxide in the second coating portion may be the same as or different from each other. When the elements are the same, for example, a crystalline coating layer and an amorphous coating layer may be formed differently, depending on the heat treatment conditions for forming the coating portion.

Preferably, elements are selected in consideration of crystallization temperature, spreadability, ionic conductivity, strength, hardness, or the like for forming a coating layer. For example, since B and W have excellent spreadability, they may be applicable to form crystalline coatings as well as amorphous coatings. In addition, since Al has a similar ionic radius to Ni³⁺ ions, the core surface and the first coating portion are very strongly bonded through a chemical bond of Al-Oₓ and thus the structural stability of the core surface area can be greatly improved. Specifically, the structure of Al-Oₓ may include one or more crystalline phases of γ-Al₂O₃, γ-Al(OH)₃, and γ-AlO(OH), and may also include other crystalline phases. In addition, Co, Zr, Ti, Si, or the like may also be more useful for formation of a coating layer.

In one specific example, the second coating portion may be formed using B and/or W with excellent spreadability. When the second coating portion forms a crystalline/amorphous combination structure, the B crystalline structure may include one or more crystalline phases of B₂O₃ (trigonal or orthorhombic), Li₂B₄O₇ (tetragonal), LiB₃O₅, Li₄B₁₀O₁₇, LiB₅O₈, Li₂B₂O₄, and Li₃B₇O₁₂, or any other crystalline phase. In addition, when the second coating portion has a crystalline/amorphous combination structure, the W crystalline structure may include at least one of h-WO₃ (hexagonal), α-WO₃ (tetragonal), β-WO₃ (orthorhombic), γ-WO₃ (monoclinic), δ-WO₃ (triclinic), ε—WO₃ (monoclinic), Li₂WO₄, Li₂W₂O₇, Li₂W₅O₁₆, Li₂W₄O₁₃, Li₆W₂O₉, Li₄WO₅, Li₆WO₆, Li₂O·5WO₃, Li₂O·4WO₃, Li₂O·2WO₃, Li₂O·WO₃, 3Li₂O·2WO₃, 2Li₂O·WO₃, or 3Li₂O·WO₃, and may include any other crystalline phases.

The first coating portion and the second coating portion may be formed, for example, by dry mixing the core with various compounds based on the elements described above, such as hydroxide, sulfate, nitrate, or carbonate and then heat treating the resulting mixture. The first coating portion with a crystalline structure may be formed by heat treatment at a relatively high temperature and the second coating portion with an amorphous structure may be formed by heat treatment at a relatively low temperature. Preferably, the first coating portion is formed on the core and then the second coating portion is formed. The method of forming the first coating portion and the second coating portion can be confirmed from the experiment details of Examples described later based on the above contents. The dry method has been proposed in terms of economic efficiency, but a wet method is also possible if necessary.

The present invention also provides a secondary battery containing the cathode active material.

Other elements constituting secondary batteries such as anode active materials, separators, electrolytes, and electrolyte solutions, and the methods of preparing the same are well known in the art and thus detailed descriptions thereof are omitted herein.

### Effects of the Invention

As described above, the cathode active material for secondary batteries according to the present invention provides secondary batteries that increase structural stability and prevent electrolyte side reactions to achieve the desired characteristics, based on a specific combination of a first coating portion that coats a part of the outer surface of the core and is stably bonded to the core to improve the structural stability of the core, and a second coating portion that coats a part of the surface of the first coating portion and an area of the core surface where the first coating portion is not formed, to minimize the area of the core surface where the coating layer is not formed.

### DESCRIPTION OF THE DRAWINGS

FIG. 1 is an exemplary schematic diagram illustrating cathode active materials on which the combination coating layer of the present invention is formed;

FIG. 2 is an image showing the result of TEM of Example 1;

FIG. 3 is an image showing the result of TEM of Example 2;

FIG. 4 is an image showing the result of TEM of Example 3;

FIG. 5 is an image showing the result of TEM of Example 6;

FIG. 6 is an image showing the result of TEM of Example 15;

FIG. 7 is an image showing the result of TEM of Comparative Example 1; and

FIG. 8 is an image showing the result of TEM of Comparative Example 2.

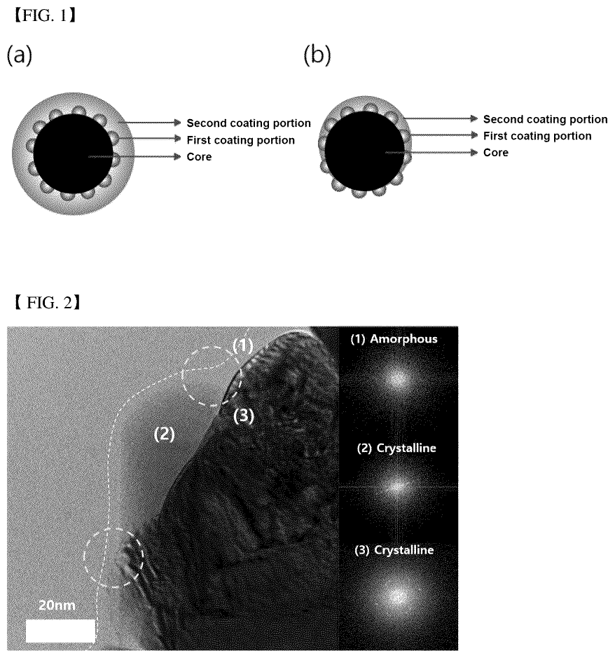

### BEST MODE

Now, the present invention will be described in more detail with reference to the following examples. These examples should not be construed as limiting the scope of the present invention.

### Example 1

A NiSO₄ compound as a nickel raw material, a CoSO₄ compound as a cobalt raw material, and a MnSO₄ compound as a manganese raw material were dissolved in distilled water at a molar ratio of Ni:Co:Mn of 96:1:3 to prepare an aqueous metal salt solution.

Caustic soda (NaOH) and an aqueous ammonia solution (NH₄OH) were continuously added to the solution in a 500 L cylindrical reactor to adjust the pH to 11.0 to 12.0 and the ammonia concentration to 4,500 to 5,500 ppm. Raw material particles were prepared for a total of 30 hours by setting a stirring speed of the reactor to 400 rpm and maintaining the temperature at 60° C.

The synthesized particles were washed, filtered and dried at 120° C. for 24 hours. As a result, a composite transition metal hydroxide powder with a D50 of 11.5 to 12.0 μm was prepared. The prepared coprecipitation compound was filtered, washed with distilled water, and dried in a hot air dryer at 110° C. for 15 hours to obtain a cathode active material precursor with the composition (Ni_{0.96}Co_{0.01}Mn_{0.03})(OH)₂.

1.03 mol of LiOH·H₂O (Albemarle Corporation), 0.025 mol of Al(OH)₃, and 0.003 mol of ZrO₂, based on 1 mol of the prepared cathode active material precursor, were dry-mixed in a Henschel 300L (Nippon Coke & Engineering) mixer in the setting conditions of 100 rpm/1 min→400 rpm/5 min→500 rpm/15 min.

A mullite sagger was filled with the mixture, placed in a roller hearth kiln (RHK), and calcined at 720° C. while maintaining oxygen (O₂) for a total of 30 hours including temperature elevation and drop periods to prepare a layered cathode active material.

Accordingly, the obtained material was pulverized and screened using an ACM (air classifier mill) to adjust an average particle diameter thereof to 11 to 12 μm (abbreviated as “bare active material”).

0.38 wt % of an Al(OH)₃ coating material was added to the active material obtained above, followed by dry-mixing using a Henschel 300L mixer under the setting conditions of 100 rpm/1 min→400 rpm/5 min→500 rpm/15 min. Then, a saggar was filled with the mixture, placed in an RHK, calcined at 450° C. for a total of 5 hours while maintaining oxygen (O₂), and then cooled to room temperature, to prepare an active material including the first coating portion on the surface thereof.

Then, in the same manner as above, 0.45 wt % of a H₃BO₃ coating material was added to the active material, followed by mixing and calcination at 300° C. for a total of 5 hours to obtain a cathode active material of Example 1 including a second coating portion on the outer surface of the first coating portion.

### Example 2

A cathode active material was prepared in substantially the same manner as in Example 1 using the bare active material prepared in Example 1, except that a second coating portion was produced by calcining 0.11 wt % of a WO₃ coating material at a temperature of 300° C.

### Example 3

A cathode active material was prepared in substantially the same coating manner as in Example 1, except that a layered bare active material with an average particle diameter of 10 to 12 μm was prepared from a cathode active material precursor of (Ni_{0.90}Co_{0.06}Mn_{0.04})(OH)₂ obtained by changing the amount of each metal raw material.

### Example 4

A cathode active material was prepared in substantially the same coating manner as in Example 2, except that a layered bare active material with an average particle diameter of 10 to 12 μm was prepared from a cathode active material precursor of (Ni_{0.90}Co_{0.06}Mn_{0.04})(OH)₂ obtained by changing the amount of each metal raw material.

### Example 5

A cathode active material was prepared in substantially the same coating manner as in Example 1, except that a layered bare active material with an average particle diameter of 10 to 12 μm was prepared from a cathode active material precursor of (Ni_{0.82}Co_{0.11}Mn_{0.07})(OH)₂ obtained by changing the amount of each metal raw material.

### Example 6

A cathode active material was prepared in substantially the same coating manner as in Example 2, except that a layered bare active material with an average particle diameter of 10 to 12 μm was prepared from a cathode active material precursor of (Ni_{0.82}Co_{0.11}Mn_{0.07})(OH)₂ obtained by changing the amount of each metal raw material.

### Example 7

A bare active material was prepared in substantially the same coating manner as in Example 5, except that a first coating portion was produced by calcining a Zr precursor at a temperature of 450° C.

### Example 8

A bare active material was prepared in substantially the same coating manner as in Example 6, except that a first coating portion was produced by calcining a Zr precursor at a temperature of 450° C.

### Example 9

A bare active material was prepared in substantially the same coating manner as in Example 5, except that a first coating portion was produced by calcining a Ti precursor at a temperature of 450° C.

### Example 10

A bare active material was prepared in substantially the same coating manner as in Example 6, except that a first coating portion was produced by calcining a Ti precursor at a temperature of 450° C.

### Example 11

A bare active material was prepared in substantially the same coating manner as in Example 5, except that a first coating portion was produced by calcining a Co precursor at a temperature of 450° C.

### Example 12

A bare active material was prepared in substantially the same coating manner as in Example 6, except that a first coating portion was produced by calcining a Co precursor at a temperature of 450° C.

### Example 13

A bare active material was prepared in substantially the same coating manner as in Example 5, except that a first coating portion was produced by calcining a Si precursor at a temperature of 450° C.

### Example 14

A bare active material was prepared in substantially the same coating manner as in Example 6, except that a first coating portion was produced by calcining a Si precursor at a temperature of 450° C.

### Example 15

A cathode active material was prepared in substantially the same coating manner as in Example 1, except that a layered bare active material with an average particle diameter of 10 to 12 μm was prepared from a cathode active material precursor of (Ni_{0.70}Co_{0.10}Mn_{0.20})(OH)₂ obtained by changing the amount of each metal raw material.

### Example 16

A cathode active material was prepared in substantially the same coating manner as in Example 2, except that a layered bare active material with an average particle diameter of 10 to 12 μm was prepared from a cathode active material precursor of (Ni_{0.70}Co_{0.10}Mn_{0.20})(OH)₂ obtained by changing the amount of each metal raw material.

### Comparative Example 1

A cathode active material was prepared using the bare active material prepared in Example 1 in substantially the same manner as in Example 1, except that the first coating portion alone was calcined at a temperature of 400° C. without the second coating portion.

### Comparative Example 2

A cathode active material was prepared using the bare active material prepared in Example 1 in substantially the same manner as in Example 1, except that the first coating portion alone was calcined using 0.45 wt % of a H₃BO₃ coating material at a temperature of 300° C.

### Comparative Example 3

A cathode active material was prepared using the bare active material prepared in Example 1 in substantially the same manner as in Example 1, except that no coating material was added.

### Experimental Example 1

The cathode active materials prepared in Examples 1, 2, 3, 6, and 15 and Comparative Examples 1 and 2 were analyzed using a transmission electron microscope (TEM). The results are shown in FIGS. 2 to 8.

First, FIG. 2 is a 500,000×TEM image of Example 1, wherein (1) shows a second coating portion, corresponding to a B amorphous coating portion, (2) shows a first coating portion, corresponding to an Al crystalline coating portion, and (3) shows a Ni_{0.96}Co_{0.01}Mn_{0.03} active material surface portion. In the TEM image, there is at least one area (circular dotted line area) where the first coating portion is discontinuously formed, which corresponds to an area where the core cannot be coated due to low spreadability of the first coating portion. In addition, it can be seen that a second coating portion is continuously further formed in the uncoated area while covering the surface of the first coating portion. In the cathode active material of Example 1, the second coating portion coats 50% of the uncoated area of the core, where the first coating portion is not formed, to compensate for the problem of uneven coating due to the low spreadability of the first coating portion.

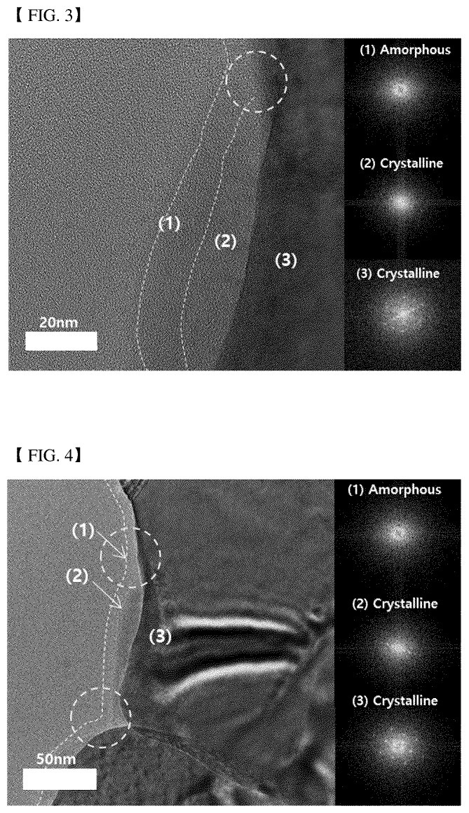

FIG. 3 is a 500,000×TEM image of Example 2, wherein (1) shows a second coating portion, corresponding to a W amorphous coating portion, (2) shows a first coating portion, corresponding to an Al crystalline coating portion, and (3) shows a Ni_{0.96}Co_{0.01}Mn_{0.03} active material surface portion. In the TEM image, there is at least one area (circular dotted line area) where the first coating portion is discontinuously formed, which corresponds to an area where the core cannot be coated due to low spreadability of the first coating portion. In addition, it can be seen that a second coating portion is continuously further formed in the uncoated area while covering the surface of the first coating portion. In the cathode active material of Example 2, the second coating portion coats 60% of the uncoated area of the core where the first coating portion is not formed, to compensate for the problem of uneven coating due to the low spreadability of the first coating portion.

FIG. 4 is a 200,000×TEM image of Example 3, wherein (1) shows a second coating portion, corresponding to a B amorphous coating portion, (2) shows a first coating portion, corresponding to an Al crystalline coating portion, and (3) shows a Ni_{0.90}Co_{0.06}Mn_{0.04} active material surface portion. In the TEM image, there is at least one area (circular dotted line area), where the first coating portion is discontinuously formed, which corresponds to an area where the core cannot be coated due to low spreadability of the first coating portion. In addition, it can be seen that a second coating portion is continuously further formed in the uncoated area while covering the surface of the first coating portion. In the cathode active material of Example 3, the second coating portion coats 70% of the uncoated area of the core where the first coating portion is not formed, to compensate for the problem of uneven coating due to the low spreadability of the first coating portion.

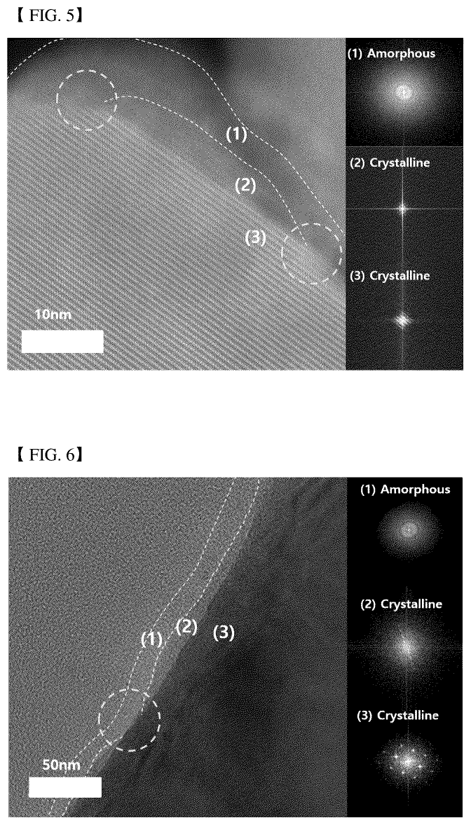

FIG. 5 is a 1,000,000×TEM image of Example 6, wherein (1) shows a second coating portion, corresponding to a W amorphous coating portion, (2) shows a first coating portion, corresponding to an Al crystalline coating portion, and (3) shows a Ni_{0.82}Co_{0.11}Mn_{0.07} active material surface portion. In the TEM image, there is at least one area (circular dotted line area), where the first coating portion is discontinuously formed, which corresponds to an area where the core cannot be coated due to low spreadability of the first coating portion. In addition, it can be seen that a second coating portion is continuously further formed in the uncoated area while covering the surface of the first coating portion. In the cathode active material of Example 6, the second coating portion coats 80% of the uncoated area of the core where the first coating portion is not formed, to compensate for the problem of uneven coating due to the low spreadability of the first coating portion.

FIG. 6 is a 200,000×TEM image of Example 15, wherein (1) shows a second coating portion, corresponding to a B amorphous coating portion, (2) shows a first coating portion, corresponding to an Al crystalline coating portion, and (3) shows a Ni_{0.70}Co_{0.10}Mn_{0.20} active material surface portion. In the TEM image, there is at least one area (circular dotted line area), where the first coating portion is discontinuously formed, which corresponds to an area where the core cannot be coated due to low spreadability of the first coating portion. In addition, it can be seen that a second coating portion is continuously further formed in the uncoated area while covering the surface of the first coating portion. In the cathode active material of Example 15, the second coating portion coats 90% of the uncoated area of the core where the first coating portion is not formed, to compensate for the problem of uneven coating due to the low spreadability of the first coating portion.

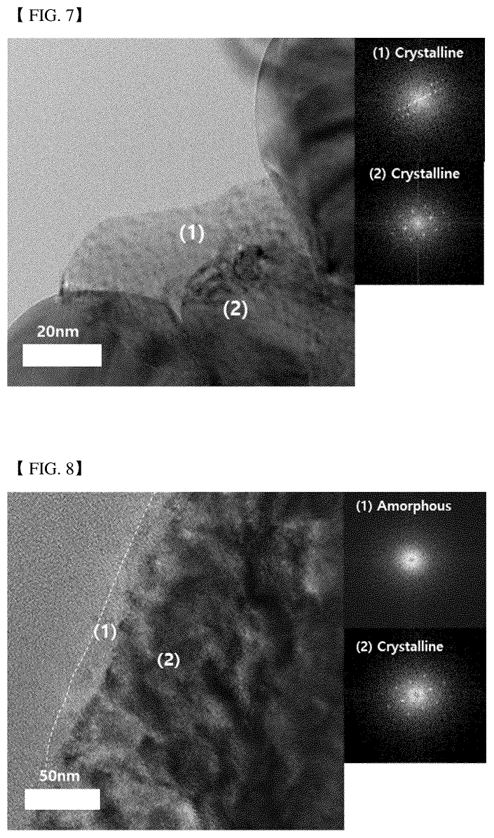

FIG. 7 is a 500,000×TEM image of Comparative Example 1, wherein (1) shows a second coating portion, corresponding to an Al amorphous coating portion, and (2) shows a Ni_{0.96}Co_{0.10}Mn_{0.03} active material surface portion. It can be seen that when only the Al crystalline coating layer is formed, an uncoated area is present on the surface of the Ni_{0.96}Co_{0.01}Mn_{0.03} active material due to low spreadability.

FIG. 8 is a 200,000×TEM image of Comparative Example 2, wherein (1) shows a second coating portion, corresponding to a B amorphous coating portion, and (2) shows a Ni_{0.96}Co_{0.10}Mn_{0.03} active material surface portion. In this case, the active material can be uniformly applied due to the high spreadability of B, but it does not form a strong bond with the active material, thus reducing the structural stability of the core surface area.

### Experimental Example 2

A 2032 coin-type half-cell was produced using the cation active material synthesized in each of Examples 1 to 16 and Comparative Examples 1 to 3, electrochemical evaluation was performed, and the results are shown in Table 1 below.

Specifically, the cathode active material, polyvinylidene fluoride as a binder (KF1100), and Super-P as a conductive material were mixed at a weight ratio of 96:2:2, and the mixture was mixed with N-methyl-2 pyrrolidone as a solvent to prepare a cathode active material slurry. Then, aluminum foil (Al foil, thickness: 20 μm), which is a cathode current collector, was coated with the slurry, dried at 120° C., and then pressed to prepare a cathode plate. The loading level of the rolled cathode was 17 mg/cm² and the rolled density was 3.3 g/cm³. The cathode plate was punched to 14@, and a 2032 coin-type half-cell was manufactured using lithium metal as an anode and an electrolyte (EC/DMC/EMC 3:4:3+1 mole of LiPF₆). The manufactured coin-type half-cell was aged at room temperature for 12 hours, and then a charge-discharge test was performed thereon.

Here, the initial charge/discharge protocol was evaluated at an operating voltage range of 2.5 to 4.25V and a current rate of 0.2 C in an environment of 25° C., and the subsequent lifespan was evaluated at a current rate of 0.3 C in a high temperature environment of 45° C.

TABLE 1

| | | | | | 30^{th} |
|---|---|---|---|---|---|
| | | | | | lifespan |
| | Charge | Discharge | | 30^{th} lifespan | resistance |
| | capacity | capacity | Efficiency | maintenance | increase |
| Item | (mAh/g) | (mAh/g) | (%) | (%) | (%) |
| Example 1 | 246.7 | 217.6 | 88.2 | 95.2 | 63.4 |
| Example 2 | 245.8 | 215.3 | 87.6 | 95.6 | 61.3 |
| Example 3 | 240.3 | 216.6 | 90.1 | 96.2 | 55.4 |
| Example 4 | 239.2 | 214.3 | 89.6 | 96.7 | 52.6 |
| Example 5 | 227.4 | 208.6 | 91.7 | 97.0 | 40.5 |
| Example 6 | 226.5 | 206.1 | 91.0 | 97.4 | 37.5 |
| Example 7 | 226.2 | 206.3 | 91.2 | 96.5 | 51.3 |
| Example 8 | 225.0 | 203.0 | 90.2 | 97.0 | 48.9 |
| Example 9 | 225.9 | 205.6 | 91.0 | 97.1 | 44.1 |
| Example 10 | 225.1 | 203.5 | 90.4 | 97.7 | 40.3 |
| Example 11 | 227.0 | 207.9 | 91.6 | 96.3 | 42.7 |
| Example 12 | 226.2 | 206.3 | 91.2 | 96.6 | 39.5 |
| Example 13 | 225.4 | 204.9 | 90.9 | 96.7 | 53.6 |
| Example 14 | 224.2 | 202.0 | 90.1 | 97.4 | 46.6 |
| Example 15 | 212.1 | 188.1 | 88.7 | 98.1 | 33.7 |
| Example 16 | 211.2 | 186.1 | 88.1 | 98.5 | 31.5 |
| Comparative | 246.5 | 212.6 | 86.3 | 93.9 | 121.1 |
| Example 1 | | | | | |
| Comparative | 246.3 | 215.8 | 87.5 | 93.1 | 156.4 |
| Example 2 | | | | | |
| Comparative | 246.6 | 208.6 | 85.8 | 91.8 | 209.7 |
| Example 3 | | | | | |

As can be seen from Table 1, Comparative Examples 1 to 3 exhibit much lower lifespan characteristics than Examples. On the other hand, the results of measurement of Examples 1 to 16 show that, when the exposure of the core surface area where the first coating portion is not formed is minimized by coating with the second coating portion, the lifespan characteristics are greatly improved. That is, it can be seen that the cathode active materials of Examples 1 to 16 have higher charge/discharge efficiency, better lifespan maintenance rate and a lower resistance increase rate, compared to the cathode active materials of Comparative Examples 1 to 3.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A cathode active material for secondary batteries comprising:
a core containing lithium transition metal oxide;
a first coating portion formed on at least a part of the surface of the core; and
a second coating portion formed on at least a part of the surface of the core where the first coating portion is not formed and optionally covering a surface of the first coating portion,
wherein the first coating portion has a relatively higher crystalline area proportion and the second coating portion has a relatively higher amorphous area proportion.

2. The cathode active material according to claim 1, wherein the lithium transition metal oxide contains a composition represented by the following Formula (1):
Li[LiₓM_{1-x-y}D_{y}]O_{2-z}Q_{z} (1)
wherein M is at least one transition metal element stable in a four-coordinate or six-coordinate system;
D is a dopant which is at least one element selected from alkaline earth metals, transition metals, and non-metals;
Q is at least one anion; and
x, y and z satisfy 0≤x≤0.1, 0≤y≤0.1, and 0≤z≤0.2, respectively.

3. The cathode active material according to claim 2, wherein M contains Ni in an amount of 60 mol % or more, based on a total content of the transition metal in the core.

4. The cathode active material according to claim 1, wherein the first coating portion optionally comprises an amorphous area and comprises a crystalline area in 70% or more of a total area of the coating portion.

5. The cathode active material according to claim 1, wherein the second coating portion optionally comprises a crystalline area and comprises an amorphous area in 70% or more of a total area of the coating portion.

6. The cathode active material according to claim 1, wherein the first coating portion is formed of a crystalline structure.

7. The cathode active material according to claim 1, wherein the second coating portion is formed of an amorphous structure.

8. The cathode active material according to claim 1, wherein the first coating portion is formed while covering 20% or more of the surface of the core.

9. The cathode active material according to claim 8, wherein the second coating portion covers 50% or more of the surface of the core where the first coating portion is not formed.

10. The cathode active material according to claim 1, wherein, in a 200,000×-1,000,000× image measured with a transmission electron microscope (TEM), there is at least one area where the first coating portion is discontinuously formed.

11. The cathode active material according to claim 1, wherein, in a 200,000×-1,000,000× image measured with a transmission electron microscope (TEM), there is at least one area where the second coating portion is formed continuously while covering the first coating portion and the core.

12. The cathode active material according to claim 1, wherein the first coating portion and the second coating portion each independently contain at least one element selected from Al, B, W, Co, Zr, Ti, Si, Mg, Ca, V, Sr, Zn, Ga, Sn, Ru, Ce, La, Hf, Ta, and Ba.

13. The cathode active material according to claim 1, wherein the first coating portion comprises at least one selected from Al, Zr, Ti, Co and Si.

14. The cathode active material according to claim 1, wherein the second coating portion comprises B and/or W.

15. The cathode active material according to claim 1, wherein, when the first coating portion comprises Al, the first coating portion comprises at least one crystalline phase selected from the group consisting of LiAlO₂, Li₃AlO₃, Al₂O₃, Al(OH)₃, and AlO(OH).

16. The cathode active material according to claim 1, wherein, when the second coating portion comprises B, the second coating portion comprises at least one crystalline phase selected from the group consisting of B₂O₃, Li₂B₄O₇, LiB₃O₅, Li₄B₁₀O₁₇, LiB₅O₈, Li₂B₂O₄, and Li₃B₇O₁₂.

17. The cathode active material according to claim 1, wherein, when the second coating portion comprises W, the second coating portion comprises at least one crystalline phase selected from the group consisting of WO₃, Li₂WO₄, Li₂W₂O₇, Li₂W₅O₁₆, Li₂W₄O₁₃, Li₆W₂O₉, Li₄WO₅, Li₆WO₆, Li₂O·5WO₃, Li₂O·4WO₃, Li₂O·2WO₃, Li₂O·WO₃, 3Li₂O·2WO₃, 2Li₂O·WO₃, and 3Li₂O·WO₃.

18. A secondary battery comprising the cathode active material according to claim 1.
